(19) United States
(12) Patent Application Publication
(10) Pub. No.: US 2012/0315589 A1
(43) Pub. Date: Dec. 13, 2012

(54) REUSABLE MUSICAL CANDLE

(76) Inventor: Seungsoo Lee, Oceanside, CA (US)

(21) Appl. No.: 13/491,302

(22) Filed: Jun. 7, 2012

(30) Foreign Application Priority Data
Jun. 10, 2011 (KR) 10-2011-0056403

(51) Int. Cl. F23D 3/16; C11C 5/00

(52) U.S. Cl. 431/253; 431/289

(57) ABSTRACT

A melody candle for reproducing sounds recorded as digital sound files includes a candle having a flammable wick having a free end and at least one optic fiber that is fastened thereto and oriented along a long dimension of said wick; a candle base having an upper surface configured to hold said candle securely; a chip group including at least one flash memory chip configured so that digital sound files can be downloaded thereto or erased therefrom; a photo sensor configured so as to activate said chip group upon receiving light emanating from a source of illumination by means of said optic fiber, said optic fiber being arranged so as to detect light emanating from said candle; and a speaker means for converting electric signals generated by said chip group into audible signals.

### CROSS-REFERENCE TO RELATED APPLICATIONS

The present application claims foreign priority to Korean Patent Application No. 2011-0056403, filed on Jun. 10, 2011, which is incorporated by reference herein in its entirety.

### FIELD OF THE INVENTION

The present invention relates to a melody candle, and more particularly, to a melody candle in which a user can add or delete sound files so that different sounds can be reproduced as the user desires.

### BACKGROUND OF THE INVENTION

As described in detail in U.S. Pat. No. 6,033,209, a melody candle generally starts playing music when it is lit. It is also designed in such a way as to enhance the decorative atmosphere of a home where it is used.

In a melody candle, an optical fiber is embedded alongside or inside its wick, as described in U.S. Pat. No. 5,921,767, so that when the wick is lit, light generated by its flame travels through the optic fiber and reaches the photo sensor located in the candle base at the bottom of the candle. Upon receiving the light, the photo sensor generates electric signals which trigger the chip group to play the sound files stored in it and sounds are reproduced through a speaker.

The candle of a melody candle is usually detachable and it is placed on the candle base as a separate unit. When the candle burns to an intended height, it is replaced with a new candle. Thus, the candle base which has sound producing mechanism can be used repeatedly as long as the used candle is replaced with a new one.

However, these conventional melody candles currently available in the market have a disadvantage of not allowing the sound files in them to be changed. The sound files in the conventional melody candles are pre-programmed and once they are stored in the melody candles, they cannot be changed by users. As a result, users are limited to listening to same melodies repeatedly and eventually become bored.

### OBJECTIVE OF THE INVENTION

The present invention aims to overcome the above-identified problem by providing a melody candle in which a user can freely add or delete sound files. Thus, the user can always listen to sounds, such as music, that the user desires.

### SUMMARY OF THE INVENTION

The present invention provides a melody candle in which an optic fiber is embedded along its wick, and a candle base whose upper surface is configured in such a way as to hold said candle securely and where a chip group that has at least one flash memory chip in which a user can add or delete sound files, a photo sensor that activates said chip group upon receiving light generated from said candle, and a speaker that converts said sound signals into sounds are located. Said chip group is connected to a USB jack that is located on the upper surface of the candle base. Said photo sensor is covered with a photo sensor cover that covers and protects the photo sensor. In the upper surface of the photo sensor cover, a guiding channel that runs vertically in the shape of a funnel is provided in the middle for the lower end of optic fiber to enter easily.

The optic fiber is inserted through a passage provided in the middle of the optic fiber anchoring device and is lowered until its lower end comes even with the lower surface of a supporting plate attached to the bottom surface of the candle. A lower portion of wick and optic fiber next to it are taped tightly and attached to the upper portion of the optic fiber anchoring device, using a non-flammable adhesive tape in such a way that when the flame reaches the non-flammable adhesive tape, the flame extinguishes itself. Said candle base is preferably made of non-flammable material such as china or ceramics.

### BRIEF DESCRIPTION OF THE DRAWINGS

FIG. 1 is a cross-sectional view of the present invention where the candle is detached from the candle base.

FIG. 2 is a cross-sectional view of the present invention where the candle is attached to the candle base.

### DETAILED DESCRIPTION OF THE PREFERRED EMBODIMENT

Hereinafter, an explanation on a melody candle according to the preferred embodiment of the present invention is given with reference to the accompanying drawings.

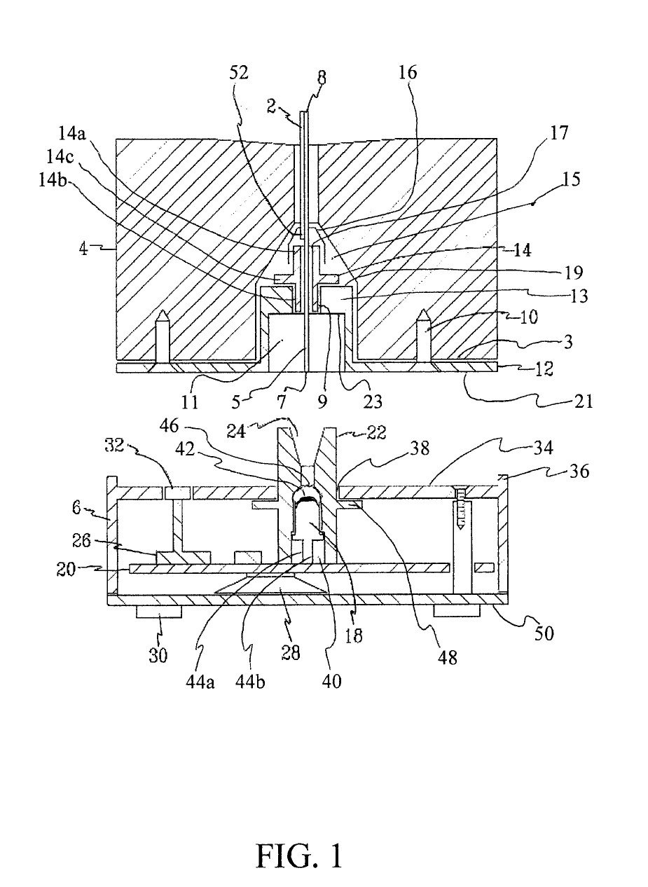

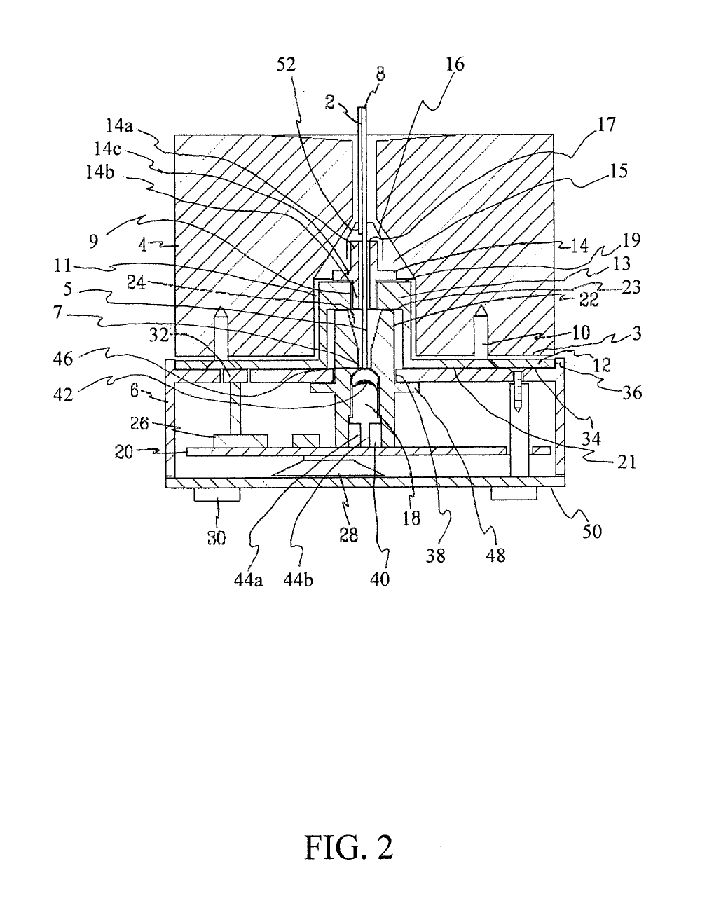

FIG. 1 is a cross-sectional view of a melody candle where the candle is detached from the candle base. FIG. 2 is a cross-sectional view of a melody candle where the candle is attached to the candle base.

According to the preferred embodiment of the present invention, the melody candle consists of a candle 4 in which a wick 2 is embedded in the middle vertically, and a candle base 6 whose upper surface 34 is designed in such a way as to hold the candle 4 in position securely and where a sound producing mechanism that produces sounds when the candle 4 burns is located. In candle 4, an optic fiber 8 is embedded alongside the wick 2 and the light generated from the flame of wick 2 travels through said optic fiber 8 to the candle base 6 and switches on the sound producing mechanism therein.

A supporting plate 12 preferably made of non-flammable material is attached to the bottom surface 3 of candle 4 by means of fastening device 10 such as screws. The diameter of supporting plate 12 is slightly smaller, preferably by less than 0.5 mm, than the inside diameter of the wall 36 of the candle base 6. Thus, the supporting plate 12 sits tightly on the upper surface 34 of the candle base 6 surrounded by the wall 36. The thickness of the supporting plate 12 is same as the height of the wall 36 so that the bottom surface 3 of candle 4 is even with the top of the wall 36 when candle 4 is placed on the upper surface 34 of the candle base 6.

The center area of supporting plate 12 protrudes upwardly in the shape of a cylinder 13. An optic fiber anchoring device 14 is provided so that the optic fiber 8 is positioned vertically along the middle of the cylinder chamber 11. The optic fiber anchoring device 14 consists of a upper portion 14a, a lower portion 14b and a skirt 14c in the middle of the optic fiber anchoring device 14. The protruding cylinder 13 is inserted upwardly into the candle chamber 15 from the bottom of the candle 4. The cylinder chamber 11 is provided for optic sensor cover 22 to enter and this is further described in detail at later time.

Protruding cylinder 13 has a cylinder opening 9 on its top surface 19 where the lower portion 14b of the optic fiber anchoring device 14 enters. An optic fiber passage 17 is provided in the middle of the optic fiber anchoring device 14, and has a diameter that is slightly larger than that of optic fiber 8, preferably larger by not more than 0.2 mm, so that said optic fiber 8 enters said optic fiber passage 17 without a problem and consistently stays in the middle of the optic fiber passage 17 with a maximum tolerance of 0.2 mm from side to side within said optic fiber passage 17.

The optic fiber 8 is lowered through the optic fiber passage 17 until the lower end 7 of the optic fiber 8 comes even with the lower surface 21 of the supporting plate 12. It is desirable that the lower end 7 of optic fiber 8 does not extend beyond the lower surface 21 of the supporting plate 12 so that when candle 4 is placed on a flat surface such as top of a table, the lower end 7 of optic fiber 8 does not come in contact with such surfaces. This is to prevent the optic fiber 8 from getting damaged or bent, resulting from such contacts.

The outside diameter of the lower portion 14b of optic fiber anchoring device 14 is configured in such a way that once its lower portion 14b is inserted into the cylinder opening 9, the lower portion 14b stays tightly in the cylinder opening 9. The skirt 14c is situated in such a location on the optic fiber anchoring device 14 that it is stopped by top surface 19 of protruding cylinder 13 and lower portion 14b is prevented from entering the cylinder chamber 11.

Because of its rigidness, the lower portion 5 of the optic fiber 8 remains straight in the middle inside the cylinder chamber 11 with its lower end 7 pointing downwardly. Cylinder chamber 11 is configured in such a way that the photo sensor cover 22 is positioned in the middle. This part will be further explained in more detail at later time.

Optic fiber 8 runs alongside wick 2 from top of candle 4, passes through optic fiber passage 17 provided in the middle of the optic fiber anchoring device 14 and it is fixed when its lower end 7 comes even with the lower surface 21 of supporting plate 12. Wick 2, on the other hand, stops when its lower end reaches the upper portion 14a of the photo sensor anchoring device 14. The lower portion 52 of wick 2 and the optic fiber 8 next to it are taped tightly, preferably in 4 to 5 layers of tape, using a non-flammable adhesive tape 16 such as aluminum foil adhesive tape. The width of said non-flammable adhesive tape 16 is preferably 15 mm, the top half of the tape 16 holding the lower portion 52 of wick 2 and the optic fiber 8 next to it firmly while the bottom half of the tape 16 is anchored to the upper portion 14a of the optic fiber anchoring device 14. This prevents the wick 2 and the optic fiber 8 from getting out of position accidentally. Said non-flammable adhesive tape 16 cuts off the supply of liquid wax to wick 2 so that when the flame of wick 2 reaches the non-flammable adhesive tape 16, it eventually extinguishes itself. This feature is provided for fire safety reasons.

The diameter of optic fiber 8 is preferably between 0.8 mm and 1 mm. It is made of polymer material and is commonly available in the market. Therefore, a more detailed explanation of optic fiber 8 is omitted.

An optic sensor cover opening 38 is provided at the center of the upper surface 34 of the base 6. Its diameter is configured in such a way that the photo sensor cover 22, which is in the shape of a cylinder with a skirt 48, tightly enters upwardly, leaving little space between the two. The photo sensor cover 22 is configured in such a way that when candle 4 is placed on the upper surface 34 of the base 6, the supporting plate 12 is tightly positioned in the middle within the wall 36 of the candle base 6. The photo sensor cover 22 is also configured in such a way that the sensing area 42 of photo sensor 18 located inside the photo sensor chamber 40 comes into close proximity, vertically aligned, with the lower end 7 of the optic fiber 8.

Photo sensor 18 is designed to send out electric signals only when it receives light. The sound producing mechanism, located inside the candle base 6, is configured in such a way that it is activated when electric signals, that is, electric current, stronger than a preset electric current arrives at the sound producing mechanism. Such electric current stronger than a preset electric current is produced by the photo sensor 18 when it is exposed to candle light generated by candle 4 by means of optic fiber 8. This, in terms of Lux, is approximately 900 Lux near the sensing area 42 of photo sensor 18. As a result, in the present invention, the sound producing mechanism does not produce sounds in darkness or in rooms lit with normal light bulbs at night, but produces sounds when candle 4 is lit or when it is exposed to environments where photo sensor 18 receives light brighter than that of normal candle light. Such an environment includes areas close to lamps lit with bright incandescent light bulbs, directly under halogen light bulbs or areas where there is bright daylight to name a few. Under such circumstances, melody candle in present invention will produce sounds accordingly. Thus, a user can listen to sounds such as music without lighting the candle 4. For example, if a user desires to listen to music from the melody candle of the present invention at night without lighting the candle, the user needs to place it near a lamp lit with bright incandescent light bulb. If a timer is connected to said lamp and controls the turning on and turning off of the lamp, melody candle of the present invention plays music only while said lamp is turned on.

Said photo sensor 18 is mounted on a PCB 20, and is covered and protected by photo sensor cover 22. A guiding channel 24 in the shape of a funnel is provided in the middle of upper portion of said photo sensor cover 22 in such a way that the lower end 7 of the photo sensor 8 enters the guiding channel 24 precisely and stops at the lower end 46 of the guiding channel 24 when the candle 4 is placed on the candle base 6.

Below the guiding channel 24 in the lower portion of the photo sensor cover 22 is a photo sensor chamber 40 provided to cover and protect the photo sensor 18. It is configured in such a way that the photo sensor 18 sits tightly within it, leaving little space between the side walls of the two and that the sensing area 42 comes close to the lower end 46 of the guiding channel 24 without going into it. It is preferable that the distance between the lower end 46 of the guiding channel 24 and the sensing area 42 of the photo sensor 18 is less than 1 mm. This can be achieved by adjusting the legs 44a and 44b of photo sensor 18 accordingly when mounting the photo sensor 18 onto PCB 20.

This configuration prevents unwanted light entering through the lower end of the photo sensor chamber 40 from reaching the sensing area 42 of photo sensor 18 as much as possible and allows only the light generated by candle wick 2 to reach the sensing area 42 of the photo sensor 18 through optic fiber 8. This gives more consistency in controlling the accuracy of turning on and turning off the sound producing mechanism in the melody candle of the present invention.

The photo sensor cover 22 has a skirt 48 provided at such a location on the outside wall of photo sensor cover 22 that the photo sensor cover 22 cannot be pulled upwardly out of the candle base 6. The height and the diameter of the photo sensor cover 22 is configured in such a way that the cylinder chamber 11 covers the upper portion of the photo sensor cover 22 that protrudes above the upper surface 34 of candle base 6 completely in all directions when the candle 4 is placed on the upper surface 34 of the candle base 6 within the wall 36 as shown in FIG. 2. As a result, the only way light can reach the sensing area 42 of photo sensor 18 is through the optic fiber 8. In order to further prevent unwanted lights from reaching the photo sensing area 42 of the photo sensor 18, the photo sensor cover 22 is made of such materials as opaque plastic. Such opaque plastic material is further preferred because their relative softness prevents damaging the surface of photo sensor 18. The photo sensor cover 22 can be also made as an integral part of upper surface 34 of the base 6 instead of a separate piece.

The candle base 6 is preferably made of non-flammable material such as china, ceramics or metal, which also enhances the appearance from the decorative point of view. Inside the candle base 6, there is a sound producing mechanism that is activated by a photo sensor 18 when light generated by flame of burning wick 2 of candle 4 travels through optic fiber 8 and reaches its sensing area 42. Some of the components of said sound producing mechanism are photo sensor 18, chip group 26, PCB 20 and a speaker 28. There may be other components such as batteries and a volume control knob (not shown), but, this type of information about electric circuitry is so commonly available in electronics industry, further explanation is omitted.

Said sound producing mechanism is secured firmly inside the candle base 6. On the lower surface 50 of the candle base 6, there are candle base legs 30 to create a space between the lower surface 50 of the candle base 6 and the flat surface on which the candle base 6 is placed. Such a space is provided so that sound can come out of the candle base 6 more freely from the speaker 28. The preferred number of candle base legs 30 is four to give stability to the candle base 6 and the preferred length of each leg is 5 mm.

Chip group 26 has at least one flash memory chip in which a user can add or delete sound files freely and whose data is not erased even if power to it is cut off. This type of flash memory chip comes in different forms such as a flash memory stick drive, a SD card, a Mini SD card or just a flash memory chip mounted on a PCB. Useful memory devices are so commonly available in the market that any further explanation about flash memory chips is omitted. For economic reasons, a plain flash memory chip (not shown) of 0.5 Giga Byte storage capacity may be mounted on PCB 20 in the present invention.

Said chip group 26 is connected to a USB jack 32, preferably located at the upper surface 34 of the candle base 6 so that the flash memory chip can easily be connected to an exterior device such as a computer by means of a USB cable (not shown). This arrangement allows a user to easily add sound files to or delete sound files from the flash memory chip. Said chip group 26 can have several different kinds of chips of different functions such as one that controls various functions of a sound producing mechanism or one that converts sound files into sound signals. These different chips can be combined into a smaller number of chips depending on the design of the chip group 26. Such components as photo sensor 18, chip group 26, USB jack 32 or speaker 28 of sound producing mechanism are mounted on or connected to a PCB 20 which is securely fastened inside the candle base 6. In addition, resistors, batteries, a volume control knob, transistors or other electric components may also be mounted on or connected to PCB 20 as they become necessary.

One of the functions of the chip group 26 is to convert sound files into sounds by means of speaker 28. The sound chip (not shown) of chip group 26 can be configured in such a way as to play as many sound file formats as possible, including such common sound file formats as wave file format, MP3 file format, AAC file format and WMA file format. For economic reasons, a sound chip that can play MP3 format and WMA format is used in the present invention.

The control chip can be programmed in many different ways to play sound files stored in the flash memory chip of chip group 26. It can be programmed to include such functions as seek, skip, fast forward or pause like the functions commonly found in MP3 players. In the present invention, the control chip plays all the sound files stored from beginning to the end, and repeats them in loop as long as the candle wick 2 is burning.

A user can download Christmas songs from a computer or a smart phone to the melody candle of the present invention and play them during Christmas season. When a different occasion, such as birthday, arrives, the user can delete Christmas songs and download birthday songs instead, and play them for a birthday party. When guests are invited for dinner, for example, the user can delete birthday songs and download pertinent music for dinner such as soft music. Then, the user may light the melody candle of the present invention and place it on the dinner table. Thus, the user can offer a candle light dinner with music to the dinner guests, enhancing the dinner atmosphere to a more pleasant level. Since the chip group 26 can play sound files, it can play not only music but any kind of sounds such as human voice such as speech, marriage proposal or sounds of nature such as wind and rain.

Adding or deleting sound files in the melody candle of the present invention is carried out by removing candle 4 from the candle base 6 and connecting the USB jack 32 and a USB port of a computer by means of a USB cable. The chip group 26 is programmed in such a way that the computer, upon being connected to USB jack 32 of the melody candle of the present invention, recognizes the presence of the flash memory chip of the chip group 26 as an external storage device and allows the user to add or delete sound files in it exactly the same way as music files are handled in a smart phone by means of a computer. If the computer is connected to an internet, sound files found on the internet can be directly downloaded to the melody candle of the present invention. Anyone with some knowledge of handling an MP3 player or a smart phone can easily add or delete sound files of their choice in the melody candle of the present invention. Thus, detailed explanation of how to add or delete sound files in the chip group 26 is omitted.

In the melody candle of the present invention, when the candle 4 is placed on the candle base 6 and the wick 2 is lit, candle 4 melts and the light generated by the flame of the wick 2 travels through the optic fiber 8. The photo sensor 18 detects said light, triggering the chip group 26 to convert sound files in it into sounds by means of speaker 28. The loudness of said sounds can be controlled by a volume control knob, which is not shown in the figures. Said sounds are produced as long as the candle wick 2 generates light and the photo sensor 18 detects it. When flame of wick 2 is extinguished and there is no other bright light in the room, photo sensor 18 no longer detects sufficient light and the sound producing mechanism stops producing sounds.

While the present invention has been described with reference to the particular illustrative embodiment, it is not to be restricted by said embodiment but only by the appended claims. It is to be appreciated that those skilled in the art can change or modify the embodiment without departing from the scope and spirit of the present invention.

### DESCRIPTION OF REFERENCE NUMBERS IN FIGS. 1 AND 2

2: The wick
3: The bottom surface of candle 4
4: The candle
5: The lower portion of optic fiber 8
6: The candle base
7: The lower end of optic fiber 8
8: The optic fiber
9: The cylinder opening at the top of the protruding cylinder 13
10: The fastening device
11: The cylinder chamber
12: The supporting plate
13: The protruding cylinder
14: The optic fiber anchoring device
14a: The upper portion of optic fiber anchoring device 14
14b: The lower portion of optic fiber anchoring device 14
14c: The skirt of optic fiber anchoring device 14
15: The candle chamber
16: The non-flammable adhesive tape
17: The optic fiber passage
18: The photo sensor
19: The top surface of the protruding cylinder 13
20: The printed circuit board (PCB)
21: The lower surface of the supporting plate 12
22: The photo sensor cover
23: The cylinder chamber ceiling
24: The guiding channel
26: The chip group
28: The speaker
30: The candle base legs
32: The USB Jack
34: The upper surface of candle base 6
36: The wall
38: The optic sensor cover opening of candle base 6
40: The photo sensor chamber
42: The sensing area of photo sensor 18
44a and 44b: The legs of photo sensor
46: The lower end of the guiding channel
48: The skirt of the photo sensor cover 22
50: The lower surface of candle base 6
52: The lower portion of wick 2

What is claimed is:

1. A melody candle for reproducing sounds recorded as digital sound files, comprising:
a candle having a flammable wick having a free end and at least one optic fiber that is fastened thereto and oriented along a long dimension of said wick;
a candle base having an upper surface configured to hold said candle securely;
a chip group including at least one flash memory chip configured so that digital sound files can be downloaded thereto or erased therefrom;
a photo sensor configured so as to activate said chip group upon receiving light emanating from a source of illumination by means of said optic fiber, said optic fiber being arranged so as to detect light emanating from said candle; and
a speaker means for converting electric signals generated by said chip group into audible signals.

2. The melody candle according to claim 1, wherein said candle base has a USB jack that is electrically connected to said chip group so as to transmit digital signals between said chip group and an external digital device connected to said USB jack.

3. The melody candle according to claim 1, wherein said photo sensor is covered and protected by a photo sensor cover so as to block said photo sensor from light that is not transmitted by said optic fiber.

4. The melody candle according to claim 3, wherein said photo sensor cover has a guiding channel that runs vertically therethrough and has a funnel-like shape arranged to receive a lower end of said optic fiber.

5. The melody candle according to claim 1, wherein a lower portion of said wick is attached to said photo sensor cover with a non-flammable tape arranged so that a flame caused by burning said flammable wick from said free end of said wick is extinguished at said tape.

6. The melody candle according to claim 1, wherein said candle base is made of at least one ceramic material.
